(19) United States
(12) Patent Application Publication
(10) Pub. No.: US 2012/0048308 A1
(43) Pub. Date: Mar. 1, 2012

(54) LENS CLEANING APPARATUS

(75) Inventor: SHAO-KAI PEI, Tu-Cheng (TW)

(73) Assignee: HON HAI PRECISION INDUSTRY CO., LTD., Tu-Cheng (TW)

(21) Appl. No.: 12/943,016

(22) Filed: Nov. 10, 2010

(30) Foreign Application Priority Data
Aug. 30, 2010 (TW) 99129156

(51) Int. Cl. B08B 3/00

(52) U.S. Cl. 134/105

(57) ABSTRACT

A lens cleaning apparatus includes a support panel for supporting lenses to be cleaned, an cover, a hot steam tank and a cooling gas tank. The support panel defines a number of through holes. The cover is used for detachably covering the support panel. The hot steam tank and the cooling gas tank are both located under the support panel. The hot steam tank and the cooling gas tank alternately supply hot steam and cooling gas to the lenses through the through holes.

### BACKGROUND

1. Technical Field

The present disclosure relates to lens clean technology, and particularly, to an apparatus for removing solidified glue.

2. Description of Related Art

Prior to a cylindrical grinding process, a number of lenses are laminated with glue, after grinding, the lenses are immersed in hot water for a predetermined length of time to remove the solidified glue between neighboring lenses, and then they are dried. However, a bit of the glue can remain on the lenses. Additionally, the hot water usually contains contaminants, and the contaminants often attach to the dried lenses. Therefore, the lenses must then go through another cleaning process, which uses more time and is redundant. Therefore, it is necessary to provide a lens cleaning apparatus.

### BRIEF DESCRIPTION OF THE DRAWINGS

Many aspects of the present lens cleaning apparatus can be better understood with reference to the following drawings. The components in the drawings are not necessarily drawn to scale, the emphasis instead being placed upon clearly illustrating the principles of the presentment apparatus. Moreover, in the drawings, like reference numerals designate corresponding parts throughout the views.

FIG. 1 is an isometric, schematic view of a lens cleaning apparatus in accordance with an exemplary embodiment of the present disclosure, the apparatus includes a housing.

FIG. 2 is an isometric, cutaway view of the housing of FIG. 1.

### DETAILED DESCRIPTION

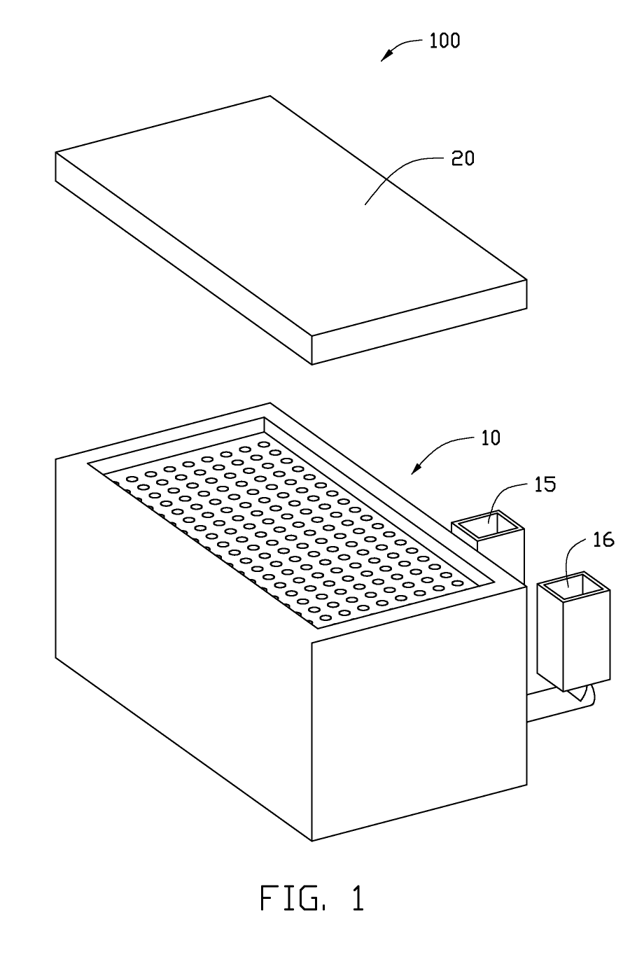

Referring to FIG. 1, a lens cleaning apparatus 100 in accordance with an exemplary embodiment is shown. The apparatus 100 includes a housing 10 and a cover 20 detachably matched with the housing 10.

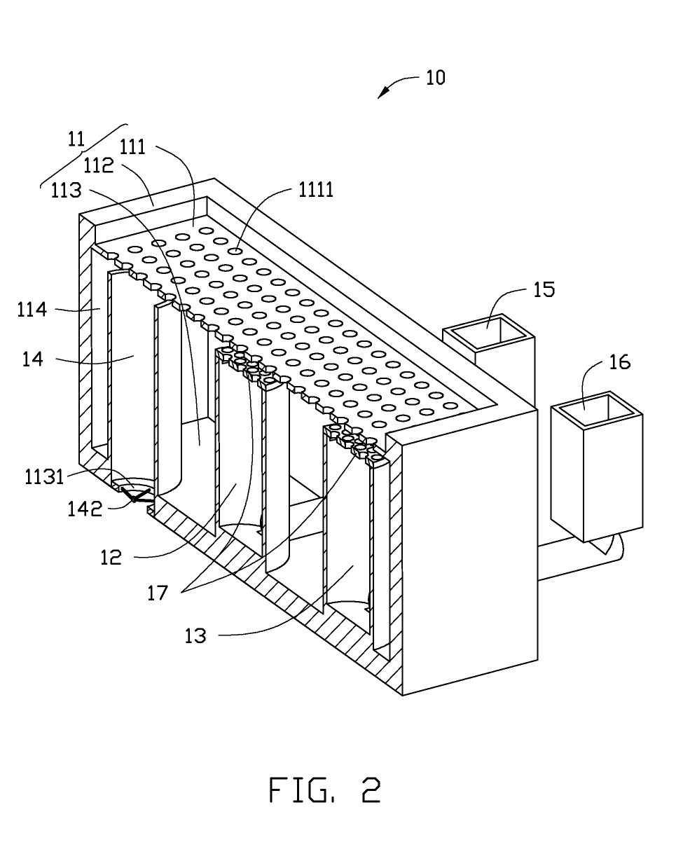

Referring to FIG. 2, the housing 10 includes an encasement 11, a hot steam tank 12, a cooling gas tank 13, an exhaust tank 14, a first guide pipe 15, a second guide pipe 16, and two filter devices 17. The encasement 11 includes a support panel 111, a bottom panel 113 opposite to the support panel 111, and a sidewall 112 interconnected with the support panel 111 and the bottom panel 113. The sidewall 112 and the bottom panel 113 cooperatively form an accommodation room 114. The support panel 111 defines a number of array-arranged through holes 1111, and is accommodated in the accommodation room 114. A distance between neighboring through holes is greater than or equal to a diameter of a lens to be cleaned.

The steam tank 12, the cooling tank 13, and the exhaust tank 14 are separated from each other, and mounted on the bottom panel 113 without reaching the support panel 111. Outlets of the steam tank 12 and the cooling tank 13 respectively face the support panel 11. The filter device is arranged between each of the hot steam tank 12 and the cooling gas tank 13 and the support panel 11. In the present embodiment, a distal end of steam tank 12 and the cooling tank 13 are respectively closed with the filter device 17. The filter device 17 can be an asbestos net, or a stainless net. A distal end of the exhaust tank 14 is opened.

The bottom panel 113 defines an opening 1131 communicating with the exhaust tank 14. A fan 142 is coaxially arranged in the opening 1131. As such, wind can be produced in the exhaust tank 14 and blown through the through hole 1111 and out of the housing 10. The first guide pipe 15 is communicating with the steam tank 12 for transporting steam thereinto. The second guide pipe 16 is communicating with the cooling tank 13 for transporting cooling gas thereinto.

In actual use, taking cleaning solidified glues attached on optical lenses for instance, the lenses are placed on the support panel 111 without blocking the through holes 1111, and the cover 10 is coupled to the encasement 11 to enclose the lenses. Steam with high temperature is introduced into the first guide pipe 15 to heat the lenses a predetermined period, such as 1 hour to 5 hours. Thus, the glue is expanded. Meanwhile, the fan 142 is operated to accelerate steam convection. Subsequently, a cooling gas, such as liquid nitrogen gas at negative 40 degrees, is introduced into the second guide pipe 16 to cool the lenses a predetermined period. Hence, the glue is contracted. In this way, an interface force between the lenses and the glue is decreased, and the glue automatically separate from the lenses. In this step, a few of glue particles are produced and fall onto the filter device 17, outside the steam tank 12 or the cooling tank 13. The steps for cooling the lenses and heating the lenses can be alternately repeated several times.

Compared with the prior art, the apparatus 100 employs the steam and the cooling gas to alternately heat and cool the lenses. Neither the steam nor the cooling gas includes contaminants. Therefore, the lenses are protected from being polluted. In addition, the apparatus 100 employs filter device 17 to prevent the glue particles from falling into the steam tank 12 and the cooling tank 13. Thus, the steam and the cooling gas are kept pure. Furthermore, the apparatus 100 employs the fan 142 to accelerate the steam and the cooling gas flow. As such, a clear efficiency can be improved.

The embodiments described are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A lens cleaning apparatus, comprising:
a support panel for supporting lenses to be cleaned, the support panel comprising a plurality of through holes;
a cover for detachably covering the supporting panel;
a hot steam tank and a cooling gas tank, the hot steam tank and the cooling gas tank located under the support panel, the steam tank and the cooling gas tank configured for alternately supplying hot steam and cooling gas to the lenses through the through holes.

2. The lens cleaning apparatus of claim 1, further comprising a bottom panel and a side wall, the side wall and the bottom panel cooperatively forms an accommodation room, the supporting panel is accommodated in the accommodation room and opposite to the bottom panel, and the steam tank and the cooling tank are mounted on the bottom panel.

3. The lens cleaning apparatus of claim 2, wherein the bottom panel comprises an opening, a fan is arranged in the opening.

4. The lens cleaning apparatus of claim 1, wherein a filter device is arranged between each of the steam tank and the cooling gas tank and the support panel.

5. The lens cleaning apparatus of claim 1, wherein the filter device is selected from the group consisting of an asbestos net and a stainless net.

6. The lens cleaning apparatus of claim 2, further comprising a first guide pipe connected with the steam tank, and a second guide pipe connected with the cooling gas tank, the first guide pipe and the second pipe extending through the side wall.

7. A lens cleaning apparatus, comprising:
a housing including a support panel, the support panel comprising a plurality of through holes;
a cover for detachably covering the supporting panel, the support panel and the cover configured for sandwiching lenses therebetween;
a hot gas tank including an outlet facing the support panel for outputting hot gas to the lenses though the through holes; and
a cooling gas tank including an outlet facing the support panel for outputting cooling gas to the lenses though the through holes, the hot steam tank and the cooling gas tank received in the housing and located under the support panel.
